(19) United States
(12) Patent Application Publication
(10) Pub. No.: US 2013/0075958 A1
(43) Pub. Date: Mar. 28, 2013

(54) PROCESS FOR PRODUCING THERMOPLASTIC RESIN FOAM

(71) Applicants: Mitsuhiro KANADA, Osaka (JP); Yoshinori KOUNO, Osaka (JP); Mie OTA, Osaka (JP); Hironori YASUDA, Osaka (JP); Kei YOSHIDA, Osaka (JP); Yuko KANDORI, Osaka (JP)

(72) Inventors: Mitsuhiro KANADA, Osaka (JP); Yoshinori KOUNO, Osaka (JP); Mie OTA, Osaka (JP); Hironori YASUDA, Osaka (JP); Kei YOSHIDA, Osaka (JP); Yuko KANDORI, Osaka (JP)

(73) Assignee: NITTO DENKO CORPORATION, Osaka (JP)

(21) Appl. No.: 13/613,779

(22) Filed: Sep. 13, 2012

(30) Foreign Application Priority Data
Sep. 28, 2011 (JP) 2011-213361

(51) Int. Cl. B29C 67/20

(52) U.S. Cl. 264/419

(57) ABSTRACT

The present invention provides a process for producing a thermoplastic resin foam excellent in strength, flexibility, cushioning properties, strain recovery, and appearance, and exhibiting little shrinkage of the cell structure under a high temperature condition and a high expansion ratio. The process includes a foamed structure formation step of foam molding a thermoplastic resin composition containing a thermoplastic elastomer and an active energy-ray curable compound to thereby obtain a foamed structure; a foamed structure conveyance step of continuously conveying the foamed structure by a carrier sheet having a surface roughness (Ra) of 1 μm or larger and a tensile break strength of 30 N/15 mm or higher, after the foamed structure formation step; and an active energy-ray irradiation step of irradiating the foamed structure with an active energy ray to thereby form a crosslinked structure by the active energy-ray curable compound in the foamed structure.

### TECHNICAL FIELD

The present invention relates to a process for producing a thermoplastic resin foam excellent in cushioning properties and strain recovery (compression set property). More particularly, the present invention relates to a process for producing a thermoplastic resin foam, which can prevent conveyance trouble during the production and stably and continuously form the thermoplastic resin foam excellent in cushioning properties and strain recovery (compression set properties).

### BACKGROUND ART

Foams (resin foams) used, for example, for internal insulators of electronic devices and the like, cushioning materials, sound insulators, heat insulators, food packaging materials, clothing materials and building materials, from the viewpoint of the sealing properties in the case where these are incorporated as components, are conventionally demanded to be flexible, high in cushioning properties, and excellent in heat insulation.

A chemical foaming process used to obtain foams and conventionally known as one usual foaming process involves forming cells by a gas generated by pyrolysis of a compound (blowing agent) added to a polymer base to thereby obtain foams.

In order to obtain a resin foam having a small cell diameter and a high cell density in the cell structure, a process has recently been proposed in which a gas such as nitrogen or carbon dioxide is dissolved at a high pressure in a polymer, and thereafter, the pressure is released and the polymer is heated up to nearly the glass transition temperature or softening point of the polymer to thereby form cells. The process in which such a gas such as nitrogen or carbon dioxide is dissolved at a high pressure in a polymer, and thereafter, the pressure is released and the polymer is heated up to, as the case may be, the glass transition temperature to thereby grow cells is an excellent process capable of forming a very fine structure. In this foaming process, nuclei are formed from a thermodynamically unstable state, and the expansion and growth of the nuclei forms cells to thereby form a fine foam.

Further, in order to fabricate a flexible foam by using this foaming process, an attempt is made to apply a thermoplastic polyurethane to a thermoplastic elastomer. For example, it is known that a thermoplastic polyurethane resin is foamed by this foaming process to thereby obtain a foam having uniform and fine cells and being hardly deformable (see Patent Literature 1).

A problem of the above process is that the polymer after the foaming shrinks, and the cell structure gradually deforms and decreases in size, resulting in not obtaining a sufficient expansion ratio. This is because in the above process, since a foaming gas such as nitrogen or carbon dioxide remaining in the cells forms the cells by the expansion and growth of cell nuclei after the pressure is released to the atmosphere, after a high expansion ratio is once formed, the foaming gas remaining in the cells gradually passes through the polymer wall.

By contrast, a proposal is made in which a thermoplastic resin composition having an ultraviolet curable resin added therein is used as a raw material, and the ultraviolet curable resin is cured by a crosslinked structure after the composition is foamed (see Patent Literature 2).

### CITATION LIST

Patent Literature

Patent Literature 1: Japanese Patent Laid-Open No. H10-168215

Patent Literature 2: Japanese Patent Laid-Open No. 2009-13397

### SUMMARY OF INVENTION

Technical Problem

However, also in the case where the ultraviolet curable resin is to be cured by a crosslinked structure, the ultraviolet curable resin is not cured right after foaming, and the foam is very flexible. Therefore, when the ultraviolet curable resin is conveyed to an active energy-ray irradiation apparatus after foaming, conveyance trouble of the foam including deformation and breakage thereof is liable to occur. That the foaming gas having passed through the polymer wall stays between a carrier sheet used in conveyance and the foam is also conceivably one cause. Since the foam right after foaming has high adhesivity, conveyance trouble is further liable to occur including adhesion of the foam to the apparatus during conveyance. Therefore, a process for producing a foam, which hardly causes such conveyance trouble and can stably provide a thermoplastic resin foam, is demanded.

Therefore, it is an object of the present invention to provide a process for producing a thermoplastic resin foam, which can stably provide a thermoplastic resin foam excellent in strength, flexibility, cushioning properties, strain recovery, appearance and the like, particularly a thermoplastic resin foam exhibiting little shrinkage of the cell structure under a high-temperature condition, and which can suppress or prevent conveyance trouble including the deformation and breakage of the foam and the adhesion of the foam to an apparatus during conveyance.

### SOLUTION TO PROBLEM

Then, as a result of exhaustive studies to solve the above-mentioned problems, the present inventors have found that the use of a carrier sheet having a surface roughness of a certain or larger roughness can provide escape paths of a foaming gas to be able to thereby suppress the staying of the foaming gas between foams and the carrier sheet. In addition, the present inventors have found that if the carrier sheet has a certain or larger strength, the adhesion of the foam to an apparatus during conveyance can be suppressed. That is, it has been found that the use of a carrier sheet having certain properties can suppress or prevent the conveyance trouble, and can stably provide a thermoplastic resin foam without causing shrinkage of the cell structure, and this finding has led to the completion of the present invention.

That is, the present invention provides a process for producing a thermoplastic resin foam, including:

a foamed structure formation step of foam molding a thermoplastic resin composition containing a thermoplastic elastomer and an active energy-ray curable compound to thereby obtain a foamed structure;

a foamed structure conveyance step of continuously conveying the foamed structure by a carrier sheet having a surface roughness (Ra) of 1 μm or larger, and a tensile break strength of 30 N/15 mm or higher, after the foamed structure formation step; and

an active energy-ray irradiation step of irradiating the foamed structure with an active energy ray to thereby form a crosslinked structure by the active energy-ray curable compound in the foamed structure.

The air permeability prescribed in the below of the carrier sheet is preferably 200 sec/100 cc or lower.

Air permeability: a time (sec) taken for 100 cm³ of air at a differential pressure of 1.23 kPa to pass through a sample of 642 mm² in air permeation area (a Gurley permeability as measured according to JIS P8117)

A blowing agent used in the foamed structure formation step is preferably carbon dioxide or nitrogen. The carbon dioxide is more preferably a liquefied carbon dioxide. The carbon dioxide is still more preferably a carbon dioxide in a supercritical state.

### ADVANTAGEOUS EFFECTS OF INVENTION

The process for producing a thermoplastic resin foam according to the present invention, since being able to prevent the conveyance trouble, can stably and efficiently provide a thermoplastic resin foam being excellent in strength, flexibility, cushioning properties, strain recovery, appearance and the like, and particularly exhibiting little shrinkage of the cell structure due to the resilience of the resin under a high-temperature condition.

### BRIEF DESCRIPTION OF DRAWINGS

FIG. 1 is a schematic diagram showing one embodiment of the process for producing a thermoplastic resin foam according to the present invention.

FIG. 2 is a schematic diagram showing another embodiment of the process for producing a thermoplastic resin foam according to the present invention.

FIG. 3 is a schematic diagram showing still another embodiment of the process for producing a thermoplastic resin foam according to the present invention.

### DESCRIPTION OF EMBODIMENTS

First, the outline of the present invention will be described based on the drawings. However, the invention indicated by each drawing is only one embodiment according to the present invention.

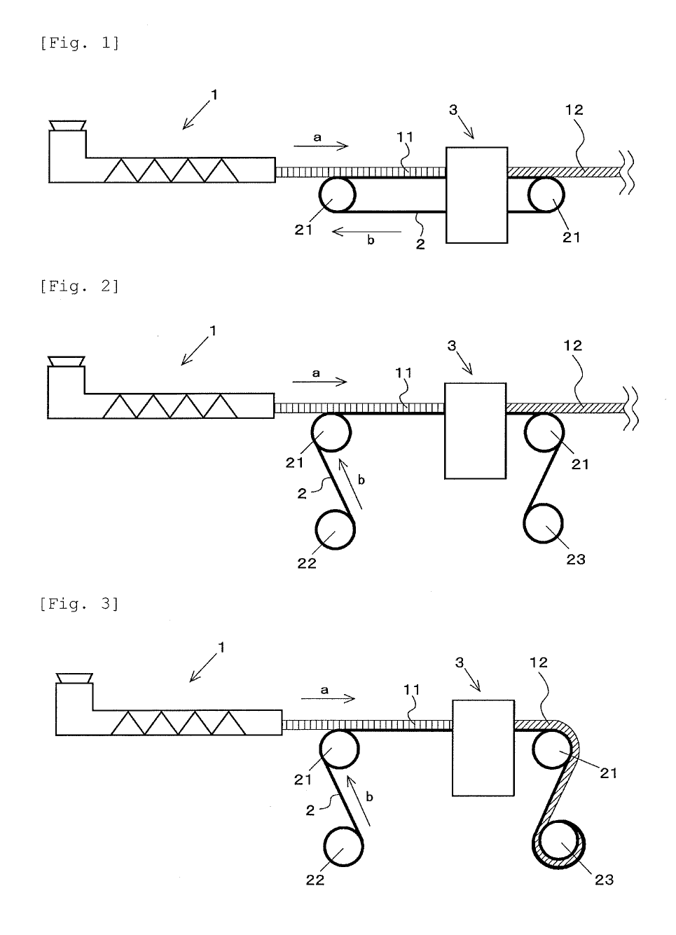

As shown in FIG. 1, in the foamed structure formation step, a thermoplastic resin composition is foam molded by a foam molding apparatus 1 to thereby form a foamed structure 11.

Then, in the foamed structure conveyance step, rolls 21 rotate to rotate a carrier sheet 2 in the direction indicated by b; and the foamed structure 11 is continuously conveyed on the carrier sheet 2 in the direction indicated by a. In the case of the present embodiment, the carrier sheet 2 is of an endless shape, and forms a loop.

Further in the active energy-ray irradiation step, the foamed structure 11 is irradiated with an active energy ray by an active energy-ray irradiation apparatus 3 to thereby obtain a thermoplastic resin foam 12.

By contrast, as shown in FIG. 2, one embodiment is conceivable in which a carrier sheet 2 is of a shape with ends forming no loop, and is supplied from a supply roll 22 in the direction indicated by b, and wound up on a take-up roll 23.

Further as shown in FIG. 3, one embodiment is also conceivable in which a carrier sheet 2 is wound up together with a thermoplastic resin foam 12 on a take-up roll 23.

The process for producing a thermoplastic resin foam according to the present invention includes the following steps. Here, a “thermoplastic resin composition containing a thermoplastic elastomer and an active energy-ray curable compound” is simply referred to as a “thermoplastic resin composition” in some cases.

[1. Foamed structure formation step]

A step of foam molding a thermoplastic resin composition to thereby form a foamed structure.

[2. Foamed structure conveyance step]

A step of continuously conveying the foamed structure by a carrier sheet having a surface roughness (Ra) of 1 μm or larger, and a tensile break strength of 30 N/15 mm or higher, after the foamed structure formation step.

[3. Active energy-ray irradiation step]

A step of irradiating the foamed structure with an active energy ray to thereby form a crosslinked structure by the active energy-ray curable compound in the foamed structure.

The process for producing a thermoplastic resin foam according to the present invention preferably further includes the following step.

[4. Foamed structure heating step]

A step of heating the foamed structure. Hereinafter, the each step will be described in detail.

[1. Foamed structure formation step]

The foamed structure formation step of foam molding a thermoplastic resin composition to thereby obtain a foamed structure is not especially limited; however, the foamed structure formation step preferably includes at least one of:

(1-A) a structure formation step of molding the thermoplastic resin composition to thereby obtain a structure;

(1-B) a blowing agent impregnation step of impregnating the thermoplastic resin composition or the structure with a blowing agent;

(1-C) a pressure-reduction step of releasing the pressure of the thermoplastic resin composition or the structure;

(1-D) a heating step of heating the thermoplastic resin composition or the structure; and

(1-E) a cooling step of cooling the thermoplastic resin composition or the structure, and more preferably includes all of (1-A) the structure formation step, (1-B) the blowing agent impregnation step and (1-C) the pressure-reduction step, still more preferably further includes (1-D) the heating step, and especially preferably further includes (1-E) the cooling step.

(System of the foamed structure formation step)

A system of the foamed structure formation step is not especially limited, but examples thereof include a batch system and a continuous system. The batch system makes a thermoplastic resin composition into a structure (unfoamed resin molded article, unfoamed molded material) by (1-A) the structure formation step, and thereafter carries out (1-B) the blowing agent impregnation step in which the structure is impregnated with a blowing agent, and (1-C) the pressure-reduction step in which the pressure of the structure is released. By contrast, in the continuous system, after (1-B) the blowing agent impregnation step in which a thermoplastic resin composition is impregnated with a blowing agent is carried out, (1-A) the structure formation step in which the thermoplastic resin composition is molded to obtain a structure and (1-C) the pressure-reduction step in which the pressure of the thermoplastic resin composition is released are both carried out. Among these systems, the continuous system is used more preferably. The reason is that although the process for producing a thermoplastic resin foam according to the present invention presents the effect of being capable of achieving a higher expansion ratio than conventional as described above, particularly the case where a foamed structure is produced by the continuous system needs foaming at an especially high expansion ratio for the reason described below, leading to the remarkable effect of the present invention.

In the case of the continuous system, the reason that the foaming needs to be carried out at an especially high expansion ratio is as follows. That is, in a kneading and impregnation step in which the structure formation step and the pressure-reduction step are both carried out, in order to hold the pressure inside an extruder or the like, for example, in the case of an extruder, the gap of a die attached to the front end needs to be made as narrow as possible. Therefore, in order to obtain a foamed structure having a sufficiently large thickness in the case of the continuous system, a thermoplastic resin composition having been extruded through a narrow gap needs to be foamed at an especially high expansion ratio.

Specifically, the gap of a die attached to the front end of an extruder in the case of the continuous system is usually 0.1 to 1.0 mm, and the thickness of a foamed structure formed by a conventional production process is limited to, for example, about 0.5 to 2.0 mm; by contrast, the process according to the invention of the present application can continuously provide a foamed structure as a foam of 0.5 to 5.0 mm in the final thickness even in such a case.

Hereinafter, the each step in the foamed structure formation step will be described in (1-1), and a foamed structure will be described in (1-2).

(1-1) Each step of the foamed structure formation step

In (1-A) to (1-E) hereinafter, the respective steps of (1-A) the structure formation step, (1-B) the blowing agent impregnation step, (1-C) the pressure-reduction step, (1-D) the heating step, and (1-E) the cooling step will be described.

(1-A) The structure formation step

The structure formation step is not especially limited as long as being a step of molding a thermoplastic resin composition to obtain a structure. Specifically, in the case where the foamed structure formation step uses a batch system, preferable examples of a process of obtaining the structure include a process in which a thermoplastic resin composition is molded using an extruder such as a single-screw extruder or a twin-screw extruder, a process in which a thermoplastic resin composition is homogeneously kneaded using a kneading machine equipped with blades such as a roller, cam, kneader or Banbury type, and then press molded into a predetermined thickness using a hot plate press or the like, and a process of molding by using an injection molding machine. Alternatively, in the case where the foamed structure formation step uses a continuous system, an example thereof includes a process in which a thermoplastic resin composition is molded using an extruder, an injection molding machine or the like, but preferable is, for example, a process of kneading by using an extruder such as a single-screw extruder or a twin-screw extruder. Among these processes, molding is carried out preferably by a suitable process capable of providing a structure having a desired shape and thickness.

As described above, in the continuous system, in the case where an extruder is used in the kneading and impregnation step in which the structure formation step and the pressure-reduction step are both carried out, the gap of a die attached to the front end needs to be made as narrow as possible, and is usually about 0.1 to 1.0 mm.

Hereinafter, a thermoplastic resin composition and a foamed structure will be described in detail in (1-A-1) and (1-A-2), respectively.

(1-A-1) A thermoplastic resin composition

In the present invention, a thermoplastic resin composition is a composition serving as a raw material of a thermoplastic resin foam, and contains, at least, a thermoplastic elastomer and an active energy-ray curable compound.

The tensile break strength of the thermoplastic resin composition is not especially limited, but is preferably 30 N/15 mm or lower. In the case where the tensile break strength of the foamed structure is 30 N/15 mm or lower, a carrier sheet functions especially effectively, and provides better conveying properties.

In a thermoplastic resin composition, the tensile stress retention (in an 80° C. atmosphere, at a 10% tensile strain, after 1,400 sec) of a 0.5-mm-thick sheet-shape unfoamed molded article obtained by molding the thermoplastic resin composition is 40% or higher, preferably 50% or higher, and more preferably 60% or higher (particularly 70% or higher). If the stress retention is 40% or higher, a high stress retention of a material for forming a foam holds the resilient stress generated when the foam is compressed, and leads to an improvement in the strain recovery rate.

The tensile stress retention (in an 80° C. atmosphere, at a 10% tensile strain, after 1,400 sec) can be determined as follows. A tensile strain of 10% is applied to a 0.5-mm-thick sheet-shape unfoamed molded article obtained from the thermoplastic resin composition, in an 80° C. atmosphere by a tensile stress relaxation measurement mode of a rheometrics dynamic viscoelasticity analyzer ARES (made by TA Instruments—Waters LLC); stresses generated right after the strain application and after 1,400 sec are measured; and the stresses are defined as an initial tensile stress and a tensile stress after 1,400 sec, respectively. Then, the tensile stress retention is determined from the following expression.

Tensile stress retention (in an 80° C. atmosphere, at a 10% tensile strain, after 1,400 sec)=a stress after 1,400 sec/an initial stress×100

The thermoplastic resin composition may specifically contain, in addition to a thermoplastic elastomer and an active energy-ray curable compound, at least one of a photopolymerization initiator, an elastomer crosslinking agent, an inorganic particle and various types of additives. Hereinafter, these components will be described in (1-A-1-1) to (1-A-1-6), and a process for producing the thermoplastic resin composition will be described in (1-A-1-7).

(1-A-1-1) A thermoplastic elastomer

A thermoplastic elastomer contained in the thermoplastic resin composition is not especially limited as long as having a rubber elasticity at normal temperature, but includes acrylic ones, urethanic ones, styrenic ones and polyesteric ones. Above all, acrylic thermoplastic elastomers are preferable because of being easy in material design. The thermoplastic resin composition may contain only one kind of, or two or more kinds of the thermoplastic elastomers.

The thermoplastic resin composition preferably contains a thermoplastic elastomer as a main component. The content of a thermoplastic elastomer in the thermoplastic resin composition is preferably 20 to 80%, and more preferably 30 to 70%, based on the total amount of the thermoplastic resin composition.

Hereinafter, the acrylic thermoplastic elastomer and the urethanic thermoplastic elastomer will be described in detail in (1-A-1-1-1) and (1-A-1-1-2), respectively.

(1-A-1-1-1) An acrylic thermoplastic elastomer

An acrylic thermoplastic elastomer is an acrylic polymer (homopolymer or copolymer) using one or two or more acrylic monomers as monomer components. The kind of the acrylic polymer is not especially limited, but is preferably one having a low glass transition temperature (for example, one having a glass transition temperature of 0° C. or lower).

The acrylic monomer is preferably an alkyl acrylate having a straight-chain or branched-chain alkyl group. The acrylic monomer (particularly acrylate ester) includes butyl acrylate (BA), ethyl acrylate (EA), 2-ethylhexyl acrylate (2-EHA), isooctyl acrylate, isononyl acrylate, propyl acrylate, isobutyl acrylate, hexyl acrylate and isobornyl acrylate (IBXA). These may be used singly or in combinations of two or more.

The acrylic monomer is preferably used as a main monomer component of the acrylic thermoplastic elastomer, and the proportion thereof is, for example, preferably 50% by weight or higher, and more preferably 70% by weight or higher, in the whole monomer component constituting the acrylic thermoplastic elastomer.

In the case where the acrylic thermoplastic elastomer is a copolymer, as required, a monomer component copolymerizable with the alkyl acrylate may be used. In the present application, a “monomer component copolymerizable with an alkyl acrylate” is referred to as “another monomer component” in some cases. The another monomer component may be used singly or in combinations of two or more.

As the another monomer component, a functional group-containing monomer is preferably used. The functional group-containing monomer is a monomer component constituting a thermoplastic elastomer, and refers to a monomer having a functional group reactive with a functional group in an elastomer crosslinking agent described later in a thermoplastic elastomer obtained by copolymerizing the monomer with a main monomer component. In the present application, a “functional group which a thermoplastic elastomer has, and which is reactive with a functional group in an elastomer crosslinking agent described later” is referred to as a “reactive functional group” in some cases.

If a functional group-containing monomer is used as the another monomer component, an acrylic thermoplastic elastomer having a reactive functional group is obtained. In the thermoplastic resin foam according to the present invention, in the case where a crosslinked structure by an elastomer crosslinking agent described later is formed, the thermoplastic elastomer is preferably an acrylic thermoplastic elastomer having a reactive functional group.

The functional group-containing monomer includes carboxyl-containing monomers such as methacrylic acid (MMA), acrylic acid (AA) and itaconic acid (IA); hydroxyl group-containing monomers such as hydroxyethyl methacrylate (HEMA) and 4-hydroxybutyl acrylate (4HBA); amide group-containing monomers such as acrylamide (AM) and methylolacrylamide (N-MAN); and cyano group-containing monomers such as acrylonitrile (AN). Above all, monomers such as methacrylic acid, acrylic acid, 4-hydroxybutyl acrylate and acrylonitrile are preferable because of being easily crosslinked, and especially acrylic acid, 4-hydroxybutyl acrylate and acrylonitrile are preferable. These may be used singly or in combinations of two or more.

The proportion of the functional group-containing monomer is preferably 1% by weight to 20% by weight, and more preferably 1% by weight to 10% by weight, based on the whole monomer component constituting the acrylic thermoplastic elastomer. In the case where the proportion is higher than this, the synthesis of the acrylic thermoplastic elastomer becomes difficult in some cases. In the case where the proportion is lower than this, a sufficient crosslinking effect cannot be developed in some cases.

Examples of another monomer component (comonomer) which is a monomer component forming the acrylic thermoplastic elastomer and is one other than the functional group-containing monomer include vinyl acetate (VAC), styrene (St), methyl methacrylate (MMA) and methyl acrylate (MA). These may be used singly or in combinations of two or more.

The proportion of the comonomer is, for example, preferably 0 to 50% by weight, and more preferably 0 to 30% by weight, based on the whole monomer component constituting the acrylic thermoplastic elastomer. If the proportion exceeds 50% by weight, properties after days are likely to decrease, which is not preferable.

Suitable selection of the kind and the proportion of the comonomer allows control of physical properties of the acrylic thermoplastic elastomer. Suitable setting of the viscoelasticity, the glass transition temperature and the elastic modulus allows control of the foaming properties of the thermoplastic resin foam.

The weight-average molecular weight of the acrylic thermoplastic elastomer is not especially limited, but is preferably 300,000 to 3,000,000. If the molecular weight is lower than this range, the elastomer cannot withstand the pressure of a blowing agent at foaming, and cells break and a sufficient cell growth cannot be achieved in some cases. Even if the molecular weight is higher than this range, no serious problem occurs, but the thermoplastic elastomer becomes too hard in molding in some cases.

(1-A-1-1-2) A urethanic thermoplastic elastomer

As a urethanic thermoplastic elastomer as a preferable thermoplastic elastomer contained as a main component in the thermoplastic resin composition, any resin can be used which is obtained by the urethanization reaction of an isocyanate compound and a polyol compound, and the elastomer is not especially limited. As the urethanic thermoplastic elastomer, a urethanic thermoplastic elastomer having a reactive functional group may be used. A urethanic thermoplastic elastomer having a reactive functional group can be obtained, for example, by a process of reserving an isocyanate group in a polymer by blending a polyol compound with an isocyanate compound of an amount excessive to an equimolar amount of the polyol compound in the polymerization.

Examples of the isocyanate compound include diisocyanate compounds such as tolylene diisocyanate, diphenylmethane diisocyanate, hexamethylene diisocyanate, naphthalene diisocyanate, isophorone diisocyanate and xylene diisocyanate. Above all, diphenylmethane diisocyanate, hexamethylene diisocyanate and the like are preferable. These may be used singly or in combinations of two or more.

Examples of the polyol compound include polyesteric polyol compounds obtained by the condensation reaction of a polyhydric alcohol such as ethylene glycol, propylene glycol, butanediol, butenediol, hexanediol, pentanediol, neopentyldiol or pentanediol with an aliphatic dicarboxylic acid such as adipic acid, sebacic acid, azelaic acid or maleic acid, or an aromatic dicarboxylic acid such as terephthalic acid or isophthalic acid; polyetheric polyol compounds such as polyethylene ether glycol, polypropylene ether glycol, polytetramethylene ether glycol and polyhexamethylene ether glycol; lactone-based polyol compounds such as polycaprolactone glycol, polypropiolactone glycol and polyvalerolactone glycol; and polycarbonate-based polyol compounds obtained by the dealcoholization reaction of a polyhydric alcohol such as ethylene glycol, propylene glycol, butanediol, pentanediol, octanediol or nonanediol with diethylene carbonate, dipropylene carbonate or the like. Low-molecular weight diols such as polyethylene glycol may also be used. Above all, polyesteric polyol compounds, polyetheric polyol compounds and the like are preferable. These may be used singly or in combinations of two or more.

(1-A-1-2) An active energy-ray curable compound

An active energy-ray curable compound contained in the thermoplastic resin composition reacts to an active energy ray to thereby form a crosslinked structure. Formation of a crosslinked structure can improve the shape fixability of the thermoplastic resin foam, and prevent the deformation and the shrinkage with time of a cell structure in the thermoplastic resin foam. The thermoplastic resin foam having such a crosslinked structure is excellent also in the strain recovery when being compressed at a high temperature, and can maintain a high expansion ratio in foaming.

The active energy-ray curable compound is not especially limited as long as being a resin which cures by irradiation of an active energy ray, but is preferably a polymerizable unsaturated compound which is nonvolatile and a low-molecular weight substance having a weight-average molecular weight of 10,000 or lower. In the present application, an “unsaturated compound which is nonvolatile and a low-molecular weight substance having a weight-average molecular weight of 10,000 or lower” is referred to as a “polymerizable unsaturated compound” in some cases.

Specific examples of the polymerizable unsaturated compound include esterified substances of (meth)acrylic acid and a polyhydric alcohol, such as phenoxypolyethylene glycol (meth)acrylate, 8-caprolactone (meth) acrylate, polyethylene glycol di(meth)acrylate, polypropylene glycol di(meth)acrylate, 1,4-butanediol di(meth)acrylate, tetraethylene glycol di(meth)acrylate, 1,6-hexanediol (meth)acrylate, trimethylolpropane tri(meth)acrylate, tetramethylolmethane tetra(meth)acrylate, pentaerythritol tri(meth)acrylate, pentaerythritol tetra(meth)acrylate and neopentylglycol di(meth)acrylate, urethane (meth)acrylates, polyfunctional urethane acrylates, epoxy (meth)acrylates, and oligoester (meth)acrylates. The polymerizable unsaturated compound may be a monomer, or an oligomer. The “(meth)acryl” used in the present invention refers to “acryl and/or methacryl”, and other derivative terms also have the similar definition. These may be used singly or in combinations of two or more.

The amount of the active energy-ray curable compound to be blended is not especially limited as long as a crosslinked structure is formed in the foamed structure by irradiation of the foamed structure with an active energy ray, but is preferably 3 to 100 parts by weight (preferably 5 to 100 parts by weight) based on 100 parts by weight of a thermoplastic elastomer. If the amount of the active energy-ray curable compound to be blended is too large (for example, if the amount of the active energy-ray curable compound to be blended exceeds 100 parts by weight based on 100 parts by weight of a thermoplastic elastomer), the hardness of the thermoplastic resin foam becomes high, and the cushioning properties decrease in some cases. By contrast, if the amount of an active energy-ray curable compound to be blended is too small (for example, if the amount of the active energy-ray curable compound to be blended is smaller than 3 parts by weight based on 100 parts by weight of a thermoplastic elastomer), a high expansion ratio cannot be maintained in some cases. The same may be said of the case where the polymerizable unsaturated compound is used as the active energy-ray curable compound.

A combination of the active energy-ray curable compound and the thermoplastic elastomer is not especially limited, but is preferably a combination having a high compatibility. More specifically, a combination of a thermoplastic elastomer and an active energy-ray curable compound is preferably a combination in which a difference Δδ (δ₁-δ₂) between the solubility parameter (SP value) δ₁ [(J/cm³)^{1/2}] of the thermoplastic elastomer and the solubility parameter (SP value) δ₂ [(J/cm³)^{1/2}] of the active energy-ray curable compound is within ±2.5 [(J/cm³)^{1/2}] (preferably, within ±2 [(J/cm³)^{1/2}]). If a combination of the active energy-ray curable compound and the thermoplastic elastomer is such a combination, since the both do not separate and exhibit very good homogeneity, the amount of the active energy-ray curable compound to be blended in the thermoplastic resin composition can be made larger. In the case where the active energy-ray curable compound and the thermoplastic elastomer correspond to such a combination, 3 to 150 parts by weight (preferably 5 to 120 parts by weight) of the active energy-ray curable compound can be blended in the thermoplastic resin composition, based on 100 parts by weight of the thermoplastic elastomer.

If a combination of an active energy-ray curable compound and a thermoplastic elastomer is a combination having a high compatibility as described above, since the amount of the active energy-ray curable compound to be blended can be made larger, the shape fixability of a thermoplastic resin foam is improved. Further with an excellent compatibility, a thermoplastic elastomer molecular chain and an active energy-ray curable compound network form an interpenetrating network (IPN) when a crosslinked structure is caused to be formed by the reaction of the active energy-ray curable compound, and also that effect improves the shape fixability of the foam.

Here, the solubility parameter (SP value) is a value determined by the calculation using Fedors method. According to the calculation expression of Fedors method, the SP value is a square root of a quotient of the sum of the molecular cohesive energy of each atomic group divided by the volume, and indicates a polarity per unit volume.

(1-A-1-3) A photopolymerization initiator

The thermoplastic resin composition according to the present invention may further contain a photopolymerization initiator. If a photopolymerization initiator is contained, a crosslinked structure is easily formed when an active energy-ray curable compound in a foamed structure obtained by foam molding the thermoplastic resin composition is caused to react by irradiation of the foamed structure with an active energy ray.

The photopolymerization initiator is not especially limited, and various types thereof can be used without especial limitations. Examples thereof include benzoin etheric photopolymerization initiators such as benzoin methyl ether, benzoin ethyl ether, benzoin propyl ether, benzoin isopropyl ether, benzoin isobutyl ether, 2,2-dimethoxy-1,2-diphenylethan-1-one and anisole methyl ether; acetophenone-based photopolymerization initiators such as 2,2-diethoxyacetophenone, 2,2-dimethoxy-2-phenylacetophenone, 1-hydroxycyclohexyl phenyl ketone, 4-phenoxydichloroacetophenone and 4-t-butyl-dichloroacetophenone; α-ketolic photopolymerization initiators such as 2-methyl-2-hydroxypropiophenone and 1-[4-(2-hydroxyethyl)-phenyl]-2-hydroxy-2-methylpropan-1-one; aromatic sulfonyl chloride-based photopolymerization initiators such as 2-naphthalene sulfonyl chloride; photoactive oxime-based photopolymerization initiators such as 1-phenyl-1,1-propanedione-2-(o-ethoxycarbonyl)-oxime; benzoin-based photopolymerization initiators such as benzoin; benzil-based photopolymerization initiators such as benzil; benzophenone-based photopolymerization initiators such as benzophenone, benzoylbenzoic acid, 3,3′-dimethyl-4-methoxybenzophenone, polyvinylbenzophenone and α-hydroxycyclohexyl phenyl ketone; ketalic photopolymerization initiators such as benzyl dimethyl ketal; thioxanthone-based photopolymerization initiators such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone and dodecylthioxanthone; α-aminoketone-based photopolymerization initiators such as 2-methyl-1-[4-(methylthio)phenyl]-2-morpholinopropan-1-one and 2-benzyl-2-dimethylamino-1-(4-morpholinophenyl)-butanone-1; and acylphosphine oxide-based photopolymerization initiators such as 2,4,6-trimethylbenzoyldiphenylphosphine oxide and bis(2,4,6-trimethylbenzoyl)-phenylphosphine oxide. These may be used singly or in combinations of two or more.

The amount of the photopolymerization initiator to be used is not especially limited, but can be selected, for example, in the range of 0.01 to 5 parts by weight (preferably 0.2 to 4 parts by weight) based on 100 parts by weight of a thermoplastic elastomer in a thermoplastic resin composition.

(1-A-1-4) An elastomer crosslinking agent

The thermoplastic resin composition may contain an elastomer crosslinking agent reactive with a reactive functional group contained in the thermoplastic resin composition. If the thermoplastic resin composition contains an elastomer crosslinking agent, in a foamed structure obtained by foam molding the thermoplastic resin composition, a crosslinked structure can be formed by heating the foamed structure or otherwise. The formation of such a crosslinked structure has advantages in points of being capable of improving the shape fixability of a thermoplastic resin foam, preventing deformation and shrinkage with time of the cell structure, and improving the strain recovery on deformation of the foam.

Examples of the elastomer crosslinking agent include polyisocyanates such as diphenylmethane diisocyanate, tolylene diisocyanate and hexamethylene diisocyanate; and polyamines such as hexamethylenediamine, triethylenetetramine, tetraethylenepentamine, hexamethylenediamine carbamate, N,N′-dicinnamylidene-1,6-hexanediamine, 4,4′-methylenebis(cyclohexylamine) carbamate and 4,4′-(2-chloroaniline). These may be used singly or in combinations of two or more.

The elastomer crosslinking agent can be used by being suitably regulated so as to provide desired properties as described later. The amount of the elastomer crosslinking agent to be used is not especially limited, but is usually about 0.01 to 10 parts by weight (preferably 0.05 to 5 parts by weight) based on 100 parts by weight of a thermoplastic elastomer in a thermoplastic resin composition.

The elastomer crosslinking agent is safely blended in a thermoplastic elastomer having a reactive functional group; and a thermoplastic elastomer having a reactive functional group, a resin having no reactive functional group, and a crosslinking agent having a reactive functional group may be used simultaneously. The elastomer crosslinking agent may be used simultaneously with various types of elastomer crosslinking aids. The amounts of these to be blended can suitably be regulated so as to provide desired properties as described later.

(1-A-1-5) An inorganic particle

In the present invention, a thermoplastic resin foam may further contain an inorganic particle. The inorganic particle can exhibit a function as a foam nucleating agent in foam molding. Therefore, blending an inorganic particle can provide a thermoplastic resin foam in a good foamed state.

The inorganic particle to be preferably used is a powdery particle having an average particle diameter (particle size) of about 0.1 to 20 μm. With the average particle diameter of an inorganic particle of smaller than 0.1 μm, the inorganic particle does not sufficiently function as a nucleating agent in some cases; with the average particle diameter of an inorganic particle exceeding 20 μm, the inorganic particle becomes a cause of escape of a blowing agent in foam molding in some cases, which is not preferable.

Examples of the powdery particle usable are inorganic particles including powdery talc, silica, alumina, zeolite, calcium carbonate, magnesium carbonate, barium sulfate, zinc oxide, titanium oxide, aluminum hydroxide, magnesium hydroxide, mica and clay such as montmorillonite, and carbon particles, glass fibers and carbon tubes. These may be used singly or in combinations of two or more.

The inorganic particle may be one having been subjected to a surface treatment. The surface treatment can enhance the affinity of the inorganic particle for the thermoplastic resin composition, and prevent the escape of a blowing agent in foaming and the shrinkage of the thermoplastic resin composition or the structure. The surface treatment can suppress the exfoliation of the inorganic particle and the thermoplastic resin composition from the interface and the escape of a blowing agent, and provide a thermoplastic resin foam in a good foamed state.

Examples of the surface treatment include a silane coupling treatment, a silica treatment, an organic acid treatment and a surfactant treatment. These treatments may be used singly or in combinations of two or more.

The amount of the inorganic particle to be blended is not especially limited, but can be suitably selected, for example, in the range of 5 to 150 parts by weight (preferably 10 to 120 parts by weight) based on 100 parts by weight of a thermoplastic elastomer. If the amount of an inorganic particle to be blended is smaller than 5 parts by weight based on 100 parts by weight of a thermoplastic elastomer, it becomes difficult to provide a homogeneous foam; by contrast, if that exceeds 150 parts by weight, the viscosity of a thermoplastic resin composition remarkably rises, and a blowing agent escapes in foam molding, posing a risk of damaging the foaming properties.

As the inorganic particle, for example, a flame retardant inorganic particle may be blended. Since a thermoplastic resin foam is constituted of a thermoplastic elastomer and has properties of being easily flammable (which can be said to be a drawback), it is preferable that the flame retardancy is imparted by the flame retardant inorganic particle. It is effective particularly in important applications such as electric and electronic devices in which the impartation of the flame retardancy is very important.

The flame retardant inorganic particle is not especially limited, but examples thereof include various types of powdery flame retardants. The flame retardant inorganic particle can be used together with an inorganic particle which is not flame retardant.

The flame retardant inorganic particle is preferably an inorganic flame retardant. Examples of the inorganic flame retardant include non-halogen and non-antimony-based inorganic flame retardants, bromine-based flame retardants, chlorine-based flame retardants, phosphorus-based flame retardants and antimony-based flame retardants, but the non-halogen and non-antimony-based inorganic flame retardants are preferable. The non-halogen and non-antimony-based inorganic flame retardants are superior to the bromine-based flame retardants and the chlorine-based flame retardants in being non-harmful to human bodies in combustion and generating no gas component having corrosiveness to devices. The non-halogen and non-antimony-based inorganic flame retardants are superior to the phosphorus-based flame retardants and the antimony-based flame retardants in having no problem of harmfulness and explosiveness. Examples of the non-halogen and non-antimony-based flame retardant include aluminum hydroxide, magnesium hydroxide, and hydrated metal oxides such as a hydrate of magnesium oxide/nickel oxide and a hydrate of magnesium oxide/zinc oxide. The hydrated metal oxide may be surface treated. These may be used singly or in combinations of two or more.

The amount of the flame retardant inorganic particle to be used is not especially limited, but can suitably be selected, for example, in the range of 5 to 150% by weight (preferably 10 to 120% by weight) based on the total amount of a thermoplastic resin composition. If the amount of the flame retardant inorganic particle to be used is too small, the flame retardancy effect becomes small; and conversely, if the amount is too large, it becomes difficult to obtain a highly foamed foam.

(1-A-1-6) Various types of additives

As required, additives may be blended in a thermoplastic resin composition. The kind of the additive is not especially limited, and various types of additives usually used in foam molding can be used. Specific examples of the additive include crystal nucleating agents, plasticizers, lubricants, colorants (pigments, dyes and the like), ultraviolet absorbents, fillers, reinforcing agents, antistatic agents, surfactants, tension modifiers, shrinkage preventive agents, fluidity modifiers, vulcanizing agents, surface treating agents, and flame retardants (various forms of flame retardants other than inorganic particles). Suitable additives among these additives may be used in consideration of desired properties including the strength, flexibility and compression set property of a thermoplastic resin foam. These may be used singly or in combinations of two or more.

The amount of the additives to be blended is not especially limited, and can be a blend amount usually used in production of thermoplastic resin foams, and may be regulated suitably in the range of not inhibiting desired properties including the strength, flexibility and compression set property of a thermoplastic resin foam.

(1-A-1-7) A process for producing the thermoplastic resin composition

The process for producing the thermoplastic resin composition is not especially limited, but the thermoplastic resin composition can be obtained, for example, by mixing, kneading, melt mixing or otherwise, as required, a thermoplastic elastomer, an active energy-ray curable compound, a photopolymerization initiator, an elastomer crosslinking agent, an elastomer crosslinking aid, an inorganic particle, and various types of additives. These processes may be used singly or in combinations of two or more.

(1-A-2) A structure

A structure is not especially limited as long as being a structure obtained by molding the thermoplastic resin composition. The shape of the structure is not especially limited, and may be any one of a roll-shape, a sheet-shape, a plate-shape and the like.

(1-B) The blowing agent impregnation step

The blowing agent impregnation step is not especially limited as long as being a step of impregnating a thermoplastic resin composition or a structure with a blowing agent. Hereinafter, the blowing agent will be described in (1-B-1), and a process for impregnating a thermoplastic resin composition or a structure with the blowing agent will be described in (1-B-2).

(1-B-1) A blowing agent

A blowing agent used in a foamed structure formation step is not especially limited as long as being a gas at normal temperature and normal pressure, and being inert to a thermoplastic elastomer and being capable of being impregnated.

The blowing agent is not especially limited, and examples thereof include rare gases (for example, helium, argon and the like), carbon dioxide, nitrogen and air; but the blowing agent is preferably carbon dioxide and nitrogen, and more preferably carbon dioxide. These blowing agents may be mixed and used.

The carbon dioxide is preferably a liquefied carbon dioxide or a carbon dioxide in a supercritical state. The liquefied carbon dioxide or carbon dioxide in a supercritical state has a high solubility to a thermoplastic elastomer. Therefore, the liquefied carbon dioxide or carbon dioxide in a supercritical state exhibits a high impregnation speed to a thermoplastic elastomer, and can be impregnated in a high concentration. If the impregnation in a high concentration is possible, since many cell nuclei are generated on sharp pressure descent after the impregnation, and the density of cells made by growth of the cell nuclei becomes large with respect to the porosity, fine cells can be obtained. Here, carbon dioxide has a critical temperature of 31° C. and a critical pressure of 7.4 MPa.

(1-B-2) A process for impregnating the thermoplastic resin composition or the structure with a blowing agent

A process for impregnating the thermoplastic resin composition or the structure with a blowing agent is not especially limited. Specifically, in the case where the foamed structure formation step is a batch system, a preferable example of the process include a high-pressure gas impregnation step in which a thermoplastic resin composition or a structure is put in a pressure-resistant vessel or a high-pressure vessel, and a high-pressure gas as a blowing agent is introduced by injection or the like. Alternatively, in the case where the foamed structure formation step is a continuous system, a preferable example thereof include a kneading and impregnation step in which a thermoplastic resin composition or a structure is kneaded using an extruder such as a single-screw extruder or a twin-screw extruder while a high-pressure gas as a blowing agent is introduced by injection or the like. In the case where the foamed structure formation step is a continuous system, the blowing agent impregnation step is carried out preferably under a pressurized condition. In any case, the introduction of the blowing agent may be carried out continuously or discontinuously.

The amount of the blowing agent to be mixed is not especially limited, but is, for example, about 2 to 10% by weight based on the total amount of a thermoplastic elastomer component, and about 2 to 5% by weight based on the total amount of the thermoplastic resin composition or the structure. The blowing agent may be mixed by suitably regulating the amount so as to provide a desired density and expansion ratio.

The pressure when the blowing agent is impregnated in a thermoplastic resin composition or a structure may be 3 MPa or higher (for example, about 3 to 50 MPa), and preferably 4 MPa or higher (for example, about 4 to 30 MPa). In the case where the pressure of the high-pressure gas is lower than 3 MPa, the cell growth in foaming is remarkable to thereby make the cell diameter too large, and be liable to cause disadvantages, for example, a decrease in the dustproofing effect, which is not preferable. This is because since a low pressure makes the amount of a blowing agent to be impregnated relatively smaller than that in a high pressure, and reduces the cell nucleus formation speed to thereby make small the number of cell nuclei to be formed, the gas amount per one cell conversely increases to thereby make the cell diameter extremely large. In the pressure region lower than 3 MPa, since the cell diameter and the cell density vary largely only by a small alteration of the impregnation pressure, it is liable to become difficult to control the cell diameter and the cell density.

The temperature when the blowing agent is impregnated in a thermoplastic resin composition or a structure depends on the kind of a high-pressure gas and a thermoplastic elastomer to be used, and the like, and can be selected in a broad range, but is, for example, about 10 to 200° C., if the operability and the like are taken into consideration. For example, in a batch system, the temperature (impregnation temperature) when a high-pressure gas as the blowing agent is impregnated in a sheet-shape thermoplastic resin composition or structure is about 10 to 200° C. (preferably 40 to 200° C.). In a continuous system, the temperature when a high-pressure gas is injected in a thermoplastic resin composition or a structure and kneaded is usually about 40 to 200° C. In the case of using carbon dioxide as a high-pressure gas, in order to hold a supercritical state, the temperature for the impregnation is preferably 32° C. or higher (especially 40° C. or higher).

(1-C) The pressure-reduction step

The pressure-reduction step is not especially limited as long as being a step of releasing the pressure of the thermoplastic resin composition or the structure. Providing the pressure-reduction step can promote generation of cell nuclei in a thermoplastic elastomer.

The form of releasing the pressure in the pressure-reduction step is not especially limited, but usually the pressure is released to the atmospheric condition. The pressure-reduction speed is not especially limited, but is preferably about 5 to 300 MPa/sec in order to obtain uniform fine cells. In the case where the foamed structure formation step is a batch system, the pressure-reduction step is preferably carried out after the blowing agent impregnation step, which is the time at which sufficient impregnation with a high-pressure gas has completed. In the case where the foamed structure formation step is a continuous system, the pressure is preferably released by extruding the thermoplastic resin composition through a die or the like installed at the front end of an extruder. The pressure can also be released similarly using an injection molding machine or the like, other than an extruder. A process capable of providing a foamed structure of a sheet-shape, a rectangular column-shape or another optional shape may suitably be selected among these processes.

(1-D) The heating step

The heating step is not especially limited as long as being a step of heating the thermoplastic resin composition or the structure. Providing the heating step promotes growth of cell nuclei and improves the efficiency of providing a foamed structure. Cell nuclei may be grown at room temperature instead of providing a heating step.

The heating temperature in the heating step is not especially limited, but is, for example, about 40 to 250° C., preferably about 40 to 100° C., and more preferably about 40 to 60° C. A heating method employable is a well-known or common method such as a water bath, oil bath, hot roll, hot air oven, far-infrared ray, near-infrared ray or microwave.

(1-E) The cooling step

The cooling step is not especially limited as long as being a step of cooling the thermoplastic resin composition or the structure. Providing the cooling step promotes the fixation of the shape of the thermoplastic resin composition or the structure, and improves the efficiency of providing a foamed structure.

The cooling step is preferably carried out after the heating step. A specific method of cooling in the cooling step is not especially limited, but preferably involves quick cooling by cold water or the like.

(1-2) A foamed structure

A foamed structure is a foam obtained by foam molding the thermoplastic resin composition, and means the foam before the formation of a crosslinked structure. The foamed structure has a cell structure (foamed structure) in the structure.

The thickness of the foamed structure is not especially limited, but is preferably 0.1 to 20 mm. The shape and the like of the foamed structure are not especially limited, and can suitably be selected according to applications or the like of a thermoplastic resin foam formed by irradiation of the foamed structure with an active energy ray, and specifically include shapes such as a sheet-shape and rectangular column-shape. The foamed structure may be processed into various shapes and thicknesses after being fabricated by the above-mentioned production process and before irradiation of an active energy ray and heating in order to form a crosslinked structure.

The relative density (a density after foaming/a density in an unfoamed state) of the foamed structure is not especially limited, but is, for example, about 0.02 to 0.3, and preferably about 0.02 to 0.25. If the relative density exceeds 0.3, the foaming is insufficient; and if being lower than 0.02, the strength of the foamed structure remarkably decreases in some cases, which is not preferable in order to provide a thick foamed structure.

The thickness, the relative density and the like of the foamed structure can be regulated by suitably selecting and setting, for example, operational conditions such as temperature, pressure and time in the structure formation step and the blowing agent impregnation step in the foamed structure formation step, operational conditions such as pressure-reduction speed, temperature and pressure in the pressure-reduction step, the heating temperature in the heating step, and the like, depending on a high-pressure gas to be used and components of a thermoplastic elastomer (thermoplastic resin).

[2. Foamed structure conveyance step]

The foamed structure conveyance step is not especially limited as long as being a step of continuously conveying the foamed structure by a carrier sheet having a surface roughness (Ra) of 1 682 m or larger and a tensile break strength of 30 N/15 mm or higher after the foamed structure formation step. Hereinafter, the carrier sheet will be described in (2-A), and a process for continuously conveying the foamed structure by the carrier sheet will be described in (2-B).

(2-A) The carrier sheet

The surface roughness (Ra) of the carrier sheet according to the present invention is 1 μm or larger, preferably 2 μm or larger, and more preferably 4 μm or larger, and usually 1 mm or smaller. In the case where the surface roughness is smaller than 1 μm, a blowing agent having escaped from the foamed structure after the foam molding of the thermoplastic resin composition stays between the foamed structure and the carrier sheet, and there arises a problem of poor appearance including a large expansion of the surface of a thermoplastic resin foam.

The carrier sheet according to the present invention needs to hold a strength in a level capable of holding a minimum tensile force capable of conveying a film-shape material, and the tensile break strength is 30 N/15 mm or higher, preferably 40 N/15 mm or higher, and more preferably 60 N/15 mm or higher. With the strength lower than this, breakage of the carrier sheet is caused during conveyance in some cases. With the strength higher than this, the carrier sheet allows continuous conveyance with no breakage, though being influenced by a tensile force of the apparatus and also the conveyance distance. Here, the tensile break strength is determined by a value measured according to JIS P8113.

The carrier sheet according to the present invention preferably has an air permeability, and the level of the Gurley permeability is, for example, 200 sec/100 cc or lower, preferably 100 sec/100 cc or lower, and more preferably 50 sec/100 cc. A blowing agent gradually escapes from the surface of a foamed structure obtained by foam molding the thermoplastic resin composition, and stays between the foamed structure and the carrier sheet, then causing the problem of poor appearance as described above. In the case where the surface roughness (Ra) of the carrier sheet is 1 μm or larger, and the Gurley permeability thereof is 200 sec/100 cc or lower, the blowing agent more hardly stays between the foamed structure and the carrier sheet, allowing more secure avoidance of the poor appearance of the foam.

The material of the carrier sheet suffices if the surface roughness (Ra) is 1 μm or larger and the tensile break strength is 30 N/15 mm or higher, and is not especially limited, but examples thereof usable are a thermoplastic resin such as a PE porous film or a PP porous film, a nonwoven fabric composed of cellulose, PET or the like, a mesh made of paper or a metal, and a metal nonwoven fabric.

(2-B) A process for continuously conveying the foamed structure by a carrier sheet

A process for continuously conveying the foamed structure by a carrier sheet is not especially limited, but an example thereof includes a process in which the foamed structure is disposed on a carrier sheet, and the foamed structure and the carrier sheet in a unified state are continuously conveyed to an active energy-ray irradiation apparatus. The disposition of the foamed structure on a carrier sheet is preferably carried out continuously. Here, “continuously” refers to that the conveyance, the disposition and the like are carried out without any discontinuation on the way.

[3. Active energy-ray irradiation step]

The active energy-ray irradiation step of irradiating the foamed structure with an active energy ray is not especially limited. Since the process for producing a thermoplastic resin foam according to the present invention has the active energy-ray irradiation step, a thermoplastic resin foam can be produced in which a crosslinked structure by the active energy-ray curable compound is formed in the foamed structure. Therefore, the thermoplastic resin foam has a good shape fixability, exhibits little deformation and shrinkage of a cell structure caused with time in the foam, and exhibits a good strain recovery. Particularly since the shrinkage of the cell structure due to the resilience of the resin is small, and a high expansion ratio in foaming can be maintained, the cushioning properties are excellent.

A specific form of the active energy-ray irradiation step conceivably involves, for example, use of an active energy ray described below and an irradiation process thereof.

The active energy ray is not especially limited, but examples thereof include ionization radiations such as a rays, β rays, γ rays, neutron beams and electron beams, and ultraviolet rays, and ultraviolet rays and electron beams are preferable.

The irradiation process including the irradiation energy and irradiation time of the active energy ray is not especially limited as long as being capable of forming a crosslinked structure by an active energy-ray curable compound. An example of such an irradiation process of an active energy ray in the case where a foamed structure is of a sheet-shape, and an ultraviolet ray is used as the active energy ray includes a process in which the sheet-shape foamed structure is irradiated on one surface thereof with an ultraviolet ray (irradiation energy: 750 mJ/cm²), and thereafter, again irradiated on the other surface with an ultraviolet ray (irradiation energy: 750 mJ/cm²). Another example thereof in the case where an electron beam is used as the active energy ray includes a process in which the sheet-shape foamed structure is irradiated on one surface thereof with an electron beam (irradiation energy: 100 kGy), and thereafter, again irradiated on the other surface with an electron beam (irradiation energy: 100 kGy). Further another example thereof includes a process in which a foamed structure disposed on a carrier sheet is irradiated with an active energy ray. More specifically, the further another example involves the irradiation of the foamed structure and the carrier sheet in a unified state in an active energy ray irradiation apparatus.

[4. Foamed structure heating step]

The process for producing a thermoplastic resin foam according to the present invention preferably includes the foamed structure heating step of heating the foamed structure. In the case where the process further includes, in addition to the active energy-ray irradiation step, the foamed structure heating step, the order of these steps is not especially limited, but the order of the active energy-ray irradiation step and the foamed structure heating step is preferable.

The heating condition of the foamed structure heating step is not especially limited, but an example thereof includes a process in which the foamed structure is left in a temperature atmosphere of 40 to 180° C. (preferably 60 to 180° C., more preferably 80 to 180° C.), for 4 min to 10 hours (preferably 30 min to 8 hours, more preferably 1 to 5 hours). Such a temperature atmosphere can be provided, for example, by a well-known heating method (for example, a heating method using an electric heater, a heating method using an electromagnetic wave such as infrared rays and a heating method using a water bath or the like). These heating methods may be used singly or in combinations of two or more.

[A thermoplastic resin foam]

In the process for producing a thermoplastic resin foam according to the present invention, a thermoplastic resin foam can be produced by irradiating the foamed structure with an active energy ray to thereby form a crosslinked structure by the active energy-ray curable compound in the foamed structure.

The expansion ratio of the thermoplastic resin foam (or foamed structure) is not especially limited, but is preferably 5 times or higher (for example, 5 times to 40 times), and more preferably 5 times to 30 times. If the expansion ratio is lower than 5 times, the flexibility decreases and the compression load particularly in a high compression state becomes large, posing a risk of causing a problem in the point of the cushioning properties.

The expansion ratio of the thermoplastic resin foam (or foamed structure) is calculated by the following expression.

Expansion ratio (times)=(a density before foaming)/(a density after foaming)

The density before foaming is, for example, a density of a thermoplastic resin composition serving as a raw material. The density after foaming is a density of a thermoplastic resin foam (or foamed structure) obtained.

The strain recovery rate (80° C., 50% compression strain) of the thermoplastic resin foam is not especially limited, but is preferably 40% or higher (for example, 40% to 95%). If the strain recovery rate is lower than 40%, the strain recovery after the foam is held in a compressed state at a high temperature is inferior, posing a risk of causing a decrease in the sealing performance at a high temperature.

A calculation method of the strain recovery rate is as follows. That is, a thermoplastic resin foam as a test piece is compressed to a thickness of 50%, and preserved in this state at 80° C. for 24 hours. After 24 hours, with the compression state being held, the temperature is returned to normal temperature, and the compression state is released. The thickness of the test piece is measured at 30 min after the release. Then, the ratio of a thickness recovered to a thickness compressed is defined as a strain recovery rate (80° C., 50% compression strain).

The shape and the thickness of the thermoplastic resin foam are not especially limited, and can suitably be selected according to applications and the like. Examples of the shape include a sheet-shape, a tape-shape and a film-shape, but a sheet-shape is preferable. The thickness can be selected, for example, in the range of about 0.1 to 10 mm (preferably 0.2 to 6 mm). In the case of using the foam in a sheet-shape, the thickness is preferably 0.1 to 20 mm, and more preferably 0.2 to 15 mm.

The density of the thermoplastic resin foam (or foamed structure) is not especially limited, and can be selected, for example, in the range of about 0.01 to 0.20 g/cm³ (preferably 0.02 to 0.15 g/cm³).

The density of the thermoplastic resin foam (or foamed structure) can be measured using an electronic specific gravimeter.

The cell structure of the thermoplastic resin foam (or foamed structure) is not especially limited, but is preferably a closed cell structure or a semi-interconnecting semi-closed cell structure. Here, the semi-interconnecting semi-closed cell structure refers to a cell structure in which a closed cell structure and an interconnecting cell structure are concurrently present.

The thermoplastic resin foam may have an adhesive layer on the surface. For example, in the case where the thermoplastic resin foam according to the present invention is a sheet-shape one, the foam may have an adhesive layer(s) on one surface or both surfaces thereof. On the adhesive layer, a transparent or colored film such as a polyolefinic film, a PET film or a polyimide film may be provided. The thermoplastic resin foam is suitably selected in the state in which a film is attached through an adhesive layer, according to applications.

The thickness and the like of the thermoplastic resin foam can be regulated by suitably selecting and setting, for example, operational conditions such as temperature, pressure and time in the structure formation step and the blowing agent impregnation step in the foamed structure formation step, operational conditions such as pressure-reduction speed, temperature and pressure in the pressure-reduction step, the heating temperature in the heating step, and the like, depending on a high-pressure gas to be used and components of a thermoplastic elastomer (thermoplastic resin).

### EXAMPLES

Hereinafter, the present invention will be described in more detail based on an Example, but the present invention is not limited to the Example.

### Example 1

A thermoplastic resin composition was obtained by charging, in a small-size pressure kneader (apparatus name: “TD-10-20MDX” (10 L), made by Toshin Co., Ltd.) equipped with two blades, to 100 parts by weight of an acrylic elastomer (acrylic acid: 5.67% by weight, weight-average molecular weight: 2,170,000 (in terms of PS)) constituted of 85 parts by weight of butyl acrylate, 15 parts by weight of acrylonitrile and 6 parts by weight of acrylic acid, 30 parts by weight of a polypropylene glycol diacrylate (bifunctional acrylate, trade name: “Aronix M270”, made by Toagosei Co., Ltd.) as an active energy-ray curable compound, 45 parts by weight of a trimethylolpropane trimethacrylate (trifunctional acrylate, trade name: “NK Ester TMPT”, made by Shin-Nakamura Chemical Co., Ltd.) as an active energy-ray curable compound, 50 parts by weight of a magnesium hydroxide (trade name: “EP1-A”, made by Konoshima Chemical Co., Ltd.) as an inorganic particle, 2 parts by weight of hexamethylenediamine (trade name: “diak No. 1”, made by Du Pont K.K.) as an elastomer crosslinking agent, 2 parts by weight of 1,3-di-o-tolylguanidine (trade name: “Nocceler DT”, made by Ouchi Shinko Chemical Industrial Co., Ltd.) as an elastomer crosslinking aid, 8 parts by weight of an antiaging agent (trade name: “Sumilizer GM”, made by Sumitomo Chemical Co., Ltd.), and 10 parts by weight of a carbon black (trade name: “#35”, made by Asahi Carbon Co., Ltd.) as a colorant, and kneading the mixture under the condition of a rotation frequency of the blades of 30 rpm and a temperature of 60° C. for about 40 min.

The thermoplastic resin composition was charged in a twin-screw single-screw extruder (a taper screw (made by Nitto Denko Corp.) and a 50-mm single-screw (made by Enpla Industries Co., Ltd.)), and fed from the twin-screw single-screw extruder to a single-screw extruder (apparatus name: “P75 Extruder”, φ75 screw full flighted, made by The Japan Steel Works, Ltd.). While the thermoplastic resin composition was kneaded under the condition of 80° C., 4 parts by weight of a gas amount (an amount corresponding to 4 parts by weight based on 100 parts by weight of the thermoplastic resin composition) of carbon dioxide was injected to thereby sufficiently impregnate the thermoplastic resin composition with carbon dioxide.

The carbon dioxide fed is a high-pressure carbon dioxide whose supply gas pressure is boosted to 28 MPa using a high-pressure pump, and the carbon dioxide injected immediately becomes a supercritical state because the temperature of a single-screw extruder is set at 80° C.

Then, the thermoplastic resin composition impregnated with carbon dioxide was extruded into the air through a circular die installed at the front end of the extruder to release the pressure to the atmospheric pressure to thereby cause the thermoplastic resin composition to foam; and a part of the cylindrical foam was continuously cut to thereby obtain sheet-shape foamed structures. This step is a molding and pressure-reduction step in which foaming and molding are simultaneously carried out.

The sheet-shape foamed structure was attached on one surface of a kraft paper (trade name: “cpK”, made by Oji Paper Co., Ltd.) in a continuous manner. The foamed structure was once irradiated on one surface thereof with an electron beam (acceleration voltage: 250 kV) so that the dose per one surface was 200 kGy. The irradiation atmosphere was made one replaced by nitrogen. This electron beam irradiation causes an active energy-ray curable compound to react to thereby form a crosslinked structure.

After the electron beam irradiation, the resultant was subjected to a heating treatment in an atmosphere of 170° C. for 1 hour. The heating treatment caused a thermoplastic elastomer component in the foam to be crosslinked to thereby impart the sheet-shape foamed structure with a crosslinked structure, to thereby obtain a sheet-shape thermoplastic resin foam.

### Comparative Example 1

A sheet-shape thermoplastic resin foam was obtained as in Example 1, except for conveying a sheet-shape foamed structure to an electron beam irradiation apparatus without using a carrier sheet. The conveyance line was installed with a plurality of metal rolls, but since the sheet-shape thermoplastic resin foam was adhered to the interior of the apparatus and the sheet broke after the adhesion, it became difficult to continuously convey the sheet, so the sheet-shape foamed structure could not be imparted with a crosslinked structure.

### Comparative Example 2

A sheet-shape thermoplastic resin foam was obtained as in Example 1, except for attaching the sheet-shape foamed structure to a PET film (trade name: “MRF38”, made by Mitsubishi Plastics, Inc.).

### Comparative Example 3

A sheet-shape thermoplastic resin foam was obtained as in Example 1, except for attaching the sheet-shape foamed structure to a nonwoven fabric (trade name: “F-18”, made by Nippon Daishowa Paperboard Co., Ltd.). With respect to the thermoplastic resin foam, there observed conveyance trouble that the base material and the foamed structure both broke during conveyance.

Evaluation of properties of the carrier sheets

The thickness, basis weight, tensile break strength, air permeability and surface roughness of the kraft paper, the PET film and the nonwoven fabric used as respective carrier sheets in Example 1 and Comparative Examples 2 and 3 are shown in the column of “properties of carrier sheet” in Table 1 shown below. The basis weight of a carrier sheet was measured according to JIS P8124, and the tensile break strength was measured according to JIS P8119 as described above. The air permeability of a carrier sheet was determined as a Gurley permeability according to JIS P8117 as described above, and was taken as an index of the air permeability. The PET film used in Comparative Example 2 exhibited no air permeation, and the Gurley permeability could not be measured.

Evaluation of the conveying properties of a foamed structure

The conveying properties of a foamed structure were evaluated according to the following standard, and the results are shown in the column of “conveying properties of foamed structure” in Table 2 shown below.

No trouble during conveyance could be observed: “good”.

The foamed structure broke during conveyance: “poor”. Continuous conveyance was difficult: “very poor”.

Evaluation of the thickness of a thermoplastic resin foam

Since a thermoplastic resin foam was flexible, the thickness of the foam was measured by a non-contact type laser displacement gauge (made by Keyence Corp.), in the state that the thermoplastic resin foam was being adsorbed on an air adsorption stage, and the results are shown in the column of “thickness” of “properties of thermoplastic resin foam” in Table 2 shown below.

Evaluation of the appearance of a thermoplastic resin foam

The appearance of a thermoplastic resin foam was evaluated according to the following standard, and the results are shown in the column of “appearance” of “properties of thermoplastic resin foam” in Table 2 shown below. Comparative Example 1 in which the conveyance itself was difficult before the electron beam irradiation was determined as “evaluation impossible”.

No presence of cells could be observed: “good”. Several of cells of about several centimeters were observed: “slightly poor”.

A large number of cells of several centimeters were generated: “poor”.

Evaluation of the expansion ratio

Densities before and after foaming were determined by measuring specific gravities using an electronic specific gravimeter (trade name: “MD-2005”, made by Alfa Mirage Co., Ltd.), and the expansion ratio was evaluated thereby. Here, the density before foaming was a density of a thermoplastic resin composition serving as a raw material, and the density after foaming was measured after the preservation for 24 hours at room temperature after the production of a foamed structure. The measurement of the density was carried out for Example 1, and an expansion ratio was calculated based on the following expression.

Expansion ratio (times)=(a density before foaming)/(a density after foaming)

According to the evaluation described above of the expansion ratio, the expansion ratio in Example 1 was 21 times.

Evaluation of the resilient load at 50% compression of a thermoplastic resin foam

The resilient load at 50% compression of the thermoplastic resin foam in Example 1 was measured according to the measurement method described in JIS K 6767. Specifically, several sheets of a test piece cut out into a circular shape of 30 mm in diameter were piled into a thickness of about 25 mm; and a stress when the piled test piece was compressed at a compression speed of 10 mm/min to a 50% thickness was converted to a stress per unit area (cm²), which was defined as a resilient load (N/cm²) at 50% compression.

According to the evaluation of the resilient load at 50% compression, the resilient load at 50% compression of the thermoplastic resin foam in Example 1 was 0.4 N/cm2.

Evaluation of the strain recovery rate of a thermoplastic resin foam

A thermoplastic resin foam was cut into a square whose one side length was 25 mm, and 5 sheets thereof were piled to make a test piece; and the thickness thereof was accurately measured. The thickness of the test piece at this time was taken as a. The test piece was compressed to a thickness (thickness b) of 50% using a spacer having the thickness b, which is half the thickness of the test piece, and preserved in this state at 80° C. for 24 hours. After 24 hours, with the compression state being kept, the temperature was returned to normal temperature, and the compression state was released. The thickness of the test piece was accurately measured at 30 min after the release. The thickness of the test piece at this time was taken as c. The ratio of a distance recovered to a distance compressed was defined as a strain recovery rate (80° C., 50% compression set).

Strain recovery rate (80° C., 50% compression set) [%]=(c−b)/(a-b)×100

According to the evaluation described above of the strain recovery rate, the strain recovery rate of the thermoplastic resin foam in Example 1 was 90%.

TABLE 1

| | Properties of Carrier Sheet | | | | |
|---|---|---|---|---|---|
| | | | Tensile | | |
| Kind of | Thick- | Basis | Break | Air | Surface |
| Carrier | ness | Weight | Strength | Permeability | Roughness |
| Sheet | [um] | [g/m²] | [N/15 mm] | [sec/100 cc] | (Ra) [um] |
| Kraft | 109 | 73 | 81 | 23.9 | 6.10 |
| Paper | | | | | |
| PET Film | 38 | 53.2 | 134 | unmeasurable | 0.09 |
| | | | | (no air | |
| | | | | permeation) | |
| Nonwoven | 60 | 18 | 24.5 | <0.1 | 6.72 |
| Fabric | | | | | |

TABLE 2

| | | Conveying | Properties of | |
|---|---|---|---|---|
| | Kind of | Properties | Thermoplastic Resin Foam | |
| | Carrier | of Foamed | Thickness | |
| | Sheet | Structure | [mm] | Appearance |
| Example 1 | Kraft Paper | good | 5 | good |
| Comparative | no use | very poor | unmeasurable | evaluation |
| Example 1 | | | | impossible |
| Comparative | PET Film | good | 5 | poor |
| Example 2 | | | | |
| Comparative | Nonwoven | poor | 5 | good |
| Example 3 | Fabric | | | |

### Industrial Applicability

Since the process for producing a thermoplastic resin foam according to the present invention can prevent the conveyance trouble due to the adhesion of the foam to an apparatus during conveyance and the deformation of the foam, and can efficiently produce the thermoplastic resin foam being excellent in strength, flexibility, cushioning properties, strain recovery and the like, and particularly exhibiting little shrinkage of the cell structure due to the resilience of the resin at a high temperature, and can achieve a high expansion ratio, the thermoplastic resin foam is useful as foams used particularly for internal insulators of electronic devices and the like, cushioning materials, sound insulators, heat insulators, food packaging materials, clothing materials and building materials.

### REFERENCE SIGNS LIST

1 FOAM MOLDING APPARATUS

2 CARRIER SHEET

3 ACTIVE ENERGY-RAY IRRADIATION APPARATUS

11 FOAMED STRUCTURE

12 THERMOPLASTIC RESIN FOAM

21 ROLL

22 SUPPLY ROLL

23 TAKE-UP ROLL

1. A process for producing a thermoplastic resin foam, comprising:
a foamed structure formation step of foam molding a thermoplastic resin composition comprising a thermoplastic elastomer and an active energy-ray curable compound to thereby obtain a foamed structure;
a foamed structure conveyance step of continuously conveying the foamed structure by a carrier sheet having a surface roughness (Ra) of 1 μM or larger and a tensile break strength of 30 N/15 mm or higher, after the foamed structure formation step; and
an active energy-ray irradiation step of irradiating the foamed structure with an active energy ray to thereby form a crosslinked structure by the active energy-ray curable compound in the foamed structure.

2. The process for producing a thermoplastic resin foam according to claim 1, wherein the carrier sheet has an air permeability prescribed in the following of 200 sec/100 cc or lower:
the air permeability: a time (sec) taken for 100 cm³ of air at a differential pressure of 1.23 kPa to pass through a sample of 642 mm² in air permeation area (a Gurley permeability as measured according to JIS P8117).

3. The process for producing a thermoplastic resin foam according to claim 1, wherein a blowing agent used in the foamed structure formation step is carbon dioxide or nitrogen.

4. The process for producing a thermoplastic resin foam according to claim 3, wherein the blowing agent used in the foamed structure formation step is a liquefied carbon dioxide.

5. The process for producing a thermoplastic resin foam according to claim 3, wherein the blowing agent used in the foamed structure formation step is a carbon dioxide in a supercritical state.
